(19) United States
(12) Patent Application Publication
(10) Pub. No.: US 2015/0152795 A1
(43) Pub. Date: Jun. 4, 2015

(54) Dynamic Cylinder Deactivation with Residual Heat Recovery

(71) Applicants: YUANPING ZHAO, SAN JOSE, CA (US); BIYUN ZHOU, SAN JOSE, CA (US)

(72) Inventors: YUANPING ZHAO, SAN JOSE, CA (US); BIYUN ZHOU, SAN JOSE, CA (US)

(73) Assignees: BIYUN ZHOU, SAN JOSE, CA (US); YUANPING ZHAO, SAN JOSE, CA (US)

(21) Appl. No.: 14/094,805

(22) Filed: Dec. 3, 2013

(51) Int. Cl. F02D 17/02

(52) U.S. Cl. CPC F02D 17/02

(57) ABSTRACT

Cylinder deactivation is a proven solution to improve engine fuel efficiency. The present invention is related to Dynamic Cylinder Deactivation (DCD) control solution to conventional multiple cylinder internal combustion engine. DCD deactivates all the cylinders within the engine alternatively, dynamically and in a way of keeping thermal balance and mechanical balance between cylinders while keeping best engine overall torque balance. DCD has many advantages over traditional sealed-valves cylinder deactivation. Variable engine displacement, thermodynamic efficiency gain and residual heat recovery are the most attractive features of DCD.

### RELATED PATENT APPLICATION

This application is a divisional of U.S. patent application Ser. No. 12/550,056, filed on Aug. 28, 2009, which claims the benefit of priority of U.S. Provisional Application No. 61/092,752 filed on Aug. 29, 2008, entitled “Dynamic Cylinder Deactivation with Residual Heat Recovery” and which are incorporated herein by reference in their entirety.

### FIELD OF THE INVENTION

The present invention relates to internal combustion engine with variable displacement control by cylinder deactivation, particularly to Dynamic Cylinder Deactivation (DCD) control method of internal combustion engine, which deactivates all the cylinders inside the engine alternatively, dynamically and in a way of keeping thermal balance and mechanical balance between cylinders while keeping best engine overall torque balance.

### BACKGROUND OF THE INVENTION

The present invention relates to Dynamic Cylinder Deactivation (DCD) solution to conventional multiple cylinder internal combustion engine. DCD is an engine cylinder deactivation solution based on engine thermodynamics and residual heat recovery. It is an innovative solution toward engine fuel conversion efficiency, totally different from traditional sealed-valves cylinder deactivation solutions.

Traditional sealed-valves cylinder deactivation solutions for internal combustion engines began in 1970s, and it was made into commercial products to Cadillac vehicles by General Motors in 1980s. It deactivates partial engine cylinders in a fixed pattern to reduce pumping loss, thus helps to increase engine fuel conversion efficiency. The big problem is such kind of deactivation causes heavy engine thermal unbalance, with the deactivated cylinders being cooler than normal and the active cylinders being hotter than normal due to heavier unit cylinder load. As a result, the cooler deactivated cylinders would suffer from reduced lubrication, thermodynamic loss and mechanical worn-out, as well as increased friction with gas blow-out, or even negative cylinder pressure with engine oil suck-in; while the hotter active cylinders would trend to knock and overheat.

Cylinder deactivation is a proven solution to save fuel. It has been adapted by majority of automobile manufacturers since its introduction. General Motors' cylinder deactivation solution is called Active Fuel Management (AFM) or Displacement on Demand (DOD). It gives a 6% to 8% improvement in fuel economy. Daimler Chrysler's cylinder deactivation solution is called Multi-Displacement System (MDS). It claims that fuel economy would be boosted by 10% to 20%. Mercedes-Benz's solution is called Active Cylinder Control (ACC), it was applied to its V12 engine only. Mitsubishi also had MD System (Modulated Displacement) in 1982 based on its 4-cylinder engine. Honda's solution is Variable Cylinder Management (VCM), and its related products are being sold on the market. Facing the current higher and higher crude oil price, more and more vehicles have been and would be integrated with cylinder deactivation solution.

Energy conservation is the best way to solve energy problem. Increase engine fuel conversion efficiency is an effective way to implement energy conservation. Most motor vehicles require fossil fuel as energy source. In US, motor vehicles consume 69% of fossil fuel energy. It is believed that much of benefit would come from fuel efficiency improvement. A 10% efficiency improvement in vehicle performance would save over $65 billion US dollars per year to import foreign oil based on the current $95 crude oil price, and reduce emissions of carbon dioxide by 171 million metric tons per year.

Therefore, a new kind of cylinder deactivation method, with reduced fuel consumption and increased fuel conversion efficiency, is desired that addresses the immediate and specific needs of reducing fossil fuel consumption, reducing greenhouse gas discharge and reducing combustion exhaust emissions.

### PRIOR ART

General Motors was the pioneer for cylinder deactivation. In early General Motors' U.S. Pat. No. 3,756,205 “Cylinders Selectively Unfueled” was the early name for cylinder deactivation. Although this disclosure used some electronic control with variable duty cycle, the cylinders being controlled were fixed ones and grouped ones. Later General Motors has filed many patents about cylinder deactivation, which were implemented by mechanically disabling valve actuations to seal both of the valves, such as the one disclosed by U.S. Pat. No. 6,360,705, and also U.S. Pat. No. 6,874,463, in which cylinders were separated into fixed groups, only predetermined group could be deactivated. The deactivation duty cycle was also fixed, either 0% or 50% under which the engine could be over-deactivated that an additional supercharger had to be mounted to cover the power loss. Dual throttles to the separated cylinder groups also had to be utilized to buffer the deactivation changeovers. According to U.S. Pat. No. 6,715,289, General Motors' inventors took the air sealed inside the cylinders as “air-springs”, meaning they would bounce back with the same expansion as they were compressed.

Ford Motors also has disclosed a group of cylinder deactivation patents, such as U.S. Pat. No. 6,023,929 and U.S. Pat. No. 7,367,180. According to the disclosure by U.S. Pat. No. 7,260,467, Ford Motors would rather not seal both intake and exhaust valves like General Motors did, instead, it preferred to let one of intake and exhaust valves open as to reduce the compression loss and to smooth engine operation.

U.S. Pat. No. 5,636,609 filed by Honda disclosed a valve operation and stoppage switchover device to implement cylinder deactivation. This invention utilizes hydraulic and mechanical way to enable and disable valve actions so as to disable cylinders. The disclosed structure is not only complicated, but also slow in respond to switchover time, as well as lacks flexibility and agility.

All of the above solutions are referred as traditional cylinder deactivation. They all utilize the method of disabling and sealing the valves of the cylinder to be deactivated. Normally they are implemented mechanically by hydraulic or electromagnetic valve actuation controls.

Cylinder deactivation also makes engine displacement variable. In the past, variable displacement engine used to be a hot dream of engine designers. Many patents have been filed in this area. U.S. Pat. No. 7,270,092 is one of them. Such kind of engines must be implemented in unique physical structures that they could hardly compatible with conventional internal combustion engine. As a result, their implementation and application could almost become very difficulty. Therefore, the real useful variable displacement engine is expected to be based on conventional internal combustion engine structure.

### BRIEF SUMMARY OF THE INVENTION

The present invention is Dynamic Cylinder Deactivation control method for internal combustion engine, or DCD for short. DCD is an electronic based cylinder deactivation method. Controlled by electronic circuits and microcontroller, DCD deactivates all the cylinders inside the engine dynamically and in a balanced way. That is, all the cylinders inside the engine would be working in an intermittent mode, being activated and deactivated alternatively. The result would be not only a well balanced engine thermal condition under which engine performance could be kept best, but also the residual heat recovery by engine thermodynamic expansion during the deactivation cycles. Based on all of these benefits, we could expect DCD would bring us higher engine fuel conversion efficiency than traditional sealed-valves cylinder deactivation.

DCD would not disable and seal the valves like what is being done in all traditional sealed-valves cylinder deactivation solutions. Instead, its deactivation would be applied cylinder by cylinder and cycle by cycle in a dynamic way, with the consideration of engine thermal balance, mechanical balance and torque balance. It disables and enables the cylinders by turning the fuel injections off and on. As a result, engine's deactivation duty cycle would be tightly controlled by electronic DCD controller's output duty cycle, which could be adjusted in fine pitches according to predetermined deactivation patterns. As soon as DCD control is switched off, original maximum engine power and torque would be fully recovered. Such kind of nice feature would be very suitable to vehicles for special services like police vehicle and military vehicle, reducing engine equivalent displacement during peaceful time, but operating at full engine displacement during special missions.

The electronic DCD control method of the present invention is very straightforward. It simply interrupts fuel injection to deactivate certain cylinder(s) in a single engine cycle, and keeps fuel injection on to activate the other cylinders during the same engine cycle, as well as turns fuel injection on to reactivate the deactivated cylinder(s) during the next engine cycle(s).

The balance of the deactivation pattern is very important. The balance in engine timing sequence would result smooth mechanical operation. The balance in deactivation duty cycle would cause balanced cylinder thermal condition and balanced cylinder temperature. All these balances would keep engine operating in a perfect condition, thus providing higher fuel conversion efficiency.

Dynamic cylinder deactivation would make engine displacement variable. Such kind of variable displacement function would happen to any DCD controlled engine naturally and automatically without extra effort. The great benefit is that the implementation is all based on conventional internal combustion engine structure and controlled electronically, with the lowest possible cost yet the highest performance. DCD has made the dream of popular variable displacement engine become true. Whenever DCD control is switched on, the space displaced by deactivated cylinders would burn no fuel and operate without combustion so that the related portion of engine displacement specified by deactivation duty cycle would be disappeared virtually. As a result, the overall equivalent engine displacement would be reduced by the percentage indicated by deactivation duty cycle. This also shows us the way how deactivation duty cycle is defined—simply the percentage of engine displacement reduction under DCD control.

To engine users and automobile consumers, the benefits of cylinder deactivation is simply reduced fuel consumption and improved fuel economy. It also helps to reduce engine emissions and CO2 discharge. Saving fuel means energy conservation, which would help to solve energy problem and ease the crude oil price. It also has positive contribution to the public communities by reducing global warming and greenhouse effects.

It is to be understood that both the foregoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous features and advantages of the present invention may be better understood by those skilled in the art by reference to the accompanying figures in which:

FIG. 1 is an example of dynamic cylinder deactivation (DCD) pattern based on 4-cylinder 4-stroke engine in accordance with the present invention;

FIG. 2 is a system block diagram of DCD control for 8-cylinder engine in accordance with the present invention;

FIG. 3 is a fuel injection event waveform diagram in accordance with DCD pattern in FIG. 1 of the present invention;

FIG. 4 is an example of dynamic cylinder deactivation (DCD) pattern based on 6-cylinder 4-stroke engine in accordance with the present invention;

FIG. 5 is a structure diagram of DCD control system in accordance with the present invention, in connection with automotive engine control system, with engine control module located at the outside of engine compartment;

FIG. 6 is a block diagram of DCD control module 1 in accordance with the present invention;

FIG. 7 is a block diagram of wideband Lambda sensor controller 11 in accordance with the present invention;

FIG. 8 is a block diagram of wideband Lambda sensor signal processing circuit 29 in accordance with the present invention;

FIG. 9 is another structure diagram of DCD control system in accordance with the present invention, in connection with automotive engine control system, with engine control module located at the inside of engine compartment;

FIG. 10 is a list of useful DCD duty cycles and their related Lambda values in accordance with the present invention; and

FIG. 11 is a performance comparison table made between traditional sealed-valves cylinder deactivation and DCD in accordance with the present invention.

### DETAILED DESCRIPTION OF THE INVENTION

Reference will now be made in detail to the presently preferred embodiments of the invention, examples of which are illustrated in the accompanying drawings.

The present invention is directed to Dynamic Cylinder Deactivation control method for internal combustion engine, or DCD for short. DCD is an electronic based cylinder deactivation method. Controlled by electronic circuits and microcontroller chips, DCD deactivates all the cylinders inside the engine dynamically and in a balanced way. That is, all the cylinders inside the engine would be working in an intermittent mode, being activated and deactivated alternatively. The result would be not only a well balanced engine thermal condition under which engine performance could be kept best, but also the residual heat recovery by engine thermodynamic expansion during the deactivation cycles. Based on all of these benefits, we could expect DCD would bring us higher engine fuel conversion efficiency than traditional sealed-valves cylinder deactivation.

In the following description, numerous specific descriptions are set forth in order to provide a thorough understanding of the present invention. It should be appreciated by those skilled in the art that the present invention may be practiced without some or all of these specific details. In some instances, well known process operations have not been described in detail in order not to obscure the present invention.

The DCD control method of the present DCD invention is very straightforward. It simply interrupts fuel injection electronically to deactivate certain cylinder(s) at a single engine cycle, and keeps fuel injection on to activate other cylinders during the same engine cycle, as well as turns fuel injection on to reactivate deactivated cylinder(s) during the next engine cycle(s). For this purpose, deactivation patterns could be generated for desired deactivation duty cycles with balanced operations. An example deactivation pattern in accordance with the present invention is shown in FIG. 1. This deactivation pattern is designed for a 4-cylinder 4-stroke engine with a repeat cycle of 3, resulting deactivation duty cycle of ⅓, or 33 percent. This means that each of the 4 cylinders would be turned off once during 3 engine cycles. For 4-stroke engines, each engine cycle covers 2 crankshaft revolutions. So this deactivation pattern would be repeated in every 6 engine revolutions, and every cylinder would be deactivated once evenly in every 6 engine revolutions.

In deactivation pattern shown in FIG. 1, the fuel injection events to be deactivated are highlighted with dark background color and white font, while other non-highlighted events belong to normally activated fuel injection events. Engine crankshaft angle (CA) is increasing in vertical direction. From upper to lower, crankshaft makes two revolutions or 720 degrees for one full engine cycle. The numbers in vertical sequence just reflect cylinder numbers and their ignition order. From left to right, engine cycles are listed horizontally. We need to deactivate 4 cylinders once in 3 engine cycles, which contains 12 fuel injection events. Since the deactivation duty cycle is 33 percent, 4 fuel injection events among 12 fuel injection events must be turned off. This means to deactivate one fuel injection event after every two active events. So the space between two deactivations would be two active events, just as the pattern shown in FIG. 1. During the first engine cycle, suppose cylinder 1 would be deactivated at first; next, cylinder 3 and cylinder 4 would be kept activated; and then, cylinder 2 would be deactivated during the same cycle. Still next, the engine goes to the second engine cycle, cylinder 4 would be deactivated only after both cylinder 1 and cylinder 3 have been activated; and then, cylinder 2 would be kept activated. During the third engine cycle, cylinder 3 would be deactivated only after cylinder 1 has been activated, and then, cylinder 4 and cylinder 2 would be kept activated. Such a 3-cycle deactivation pattern would be repeated as long as the deactivation is in action, yielding 33 percent of deactivation duty cycle.

The balance of the deactivation pattern is very important. The deactivation balance along engine timing sequence could result engine mechanical balance, engine thermal balance and engine torque balance. Only equal spaced deactivation pattern would keep engine operation under these three important balances. The fixed value in deactivation duty cycle would also cause balanced cylinder thermal condition and balanced cylinder temperature. All these balances would keep engine operating in a perfect condition, at least not very much down-graded from its original condition, thus providing higher fuel conversion efficiency.

Once the above deactivation pattern is implemented, another great benefit to come is residual heat recovery. In the example pattern shown in FIG. 1, before each deactivation, every cylinder has been activated regularly for two engine cycles; its temperature has reached normal operation level. During the deactivation cycle, cold air would be sucked into the hot cylinder as usual, being compressed and heated up by the residual heat left by the previous active cycle(s), and then expanded with the residual heat energy absorbed from the cylinder. In other word, such a deactivated 4-stroke engine cycle still has a source of heat addition from the remaining heat energy contained in the cylinder. As a result, the deactivated cylinder would still contribute some positive mechanical work based on the residual heat energy contained in the cylinder. Such kind of new engine cycle is inspired by the concept of High Efficiency Integrated Heat Engine (HEIHE), and can be referred as a simplified HEIHE cycle.

Once cylinders are deactivated, the exhaust displaced from DCD controlled engine would become oxygen-rich, with higher oxygen content. The higher oxygen content in the exhaust would help to oxidize the emission gases, resulting much cleaner engine exhaust. However, the original oxygen balance determined by stoichiometric relative air-fuel-ratio, or Lambda equals to one, would no longer exist. Lambda valve in accordance with the present invention would become greater than one, or even up to three or four. In this case, conventional narrow band Lambda sensor would fail to work, thus being unable to close fuel control loop. To close fuel control loop under new oxygen balance, or high Lambda value caused by DCD, a wideband Lambda sensor must be used to detect exhaust gas flow.

Academically, the residual heat recovery cycle that happens along with dynamic cylinder deactivation (DCD) could be referred as combined cycle of a heat engine, with its topping cycle being the regular air-fuel mixture combustion cycle; and its bottoming cycle being the cycle driven by air expansion with residual heat. During such combined engine cycle, both topping and bottoming cycles have their own heat sources and their own working fluids, but timely share the same cylinder space as their expanders. For the topping cycle, the heat source is from fuel combustion heat, and the working fluid is combustion products; for the bottoming cycle, the heat source is from cylinder residual heat, and the working fluid is inlet air. Both of these cycles would contribute positive work to the engine output, but in different energy contents. The fuel conversion efficiency under such combined engine cycle could be higher due to less fuel consumption but no less engine working torque generated proportionally.

Excluding a few outdated carbureted engines and single point carburetor-injected engines, most of the modern internal combustion engines are suitable for dynamic cylinder deactivation control. Basically, DCD requires that engine has multiple cylinder structure, at least two, but not limited to two cylinders. Conventional 4-cylinder, 6-cylinder, both inline-6 and V6, and 8-cylinder or V8 engines are all suitable to apply DCD control. Rare hard-to-find 3-cylinder, 5-cylinder, and 7-cylinder engines are also nice to mount DCD control. DCD also requires that the fuel of the engine under DCD control would be supplied by electronically controlled multiple point fuel injection system, be controlled by engine control module and be actuated by fuel injection devices. The ignition method to DCD controlled engine could be either spark ignition, or compression ignition. The engine cyclic operation could contain either four strokes per engine cycle, or two strokes per engine cycle. The fuel of the engine under DCD control could be any kind of liquid fuel such as gasoline, diesel, bio-diesel, ethanol, E85 or LPG; or any kind of gaseous fuel such as natural gas, propane, CNG, or hydrogen.

Modern engines are controlled by computer or microcontroller. Usually the electronic computer or microcontroller dedicated for engine control is called engine control module. Each manufacturer has different name for engine control module. For example, Ford, Mazda and General Motors name it PCM, meaning Powertrain Control Module; Toyota and Cummins name it ECM, meaning Electronic Control Module; Volkswagen names it MCU, meaning Motronic Control Module; and Nissan, Hyundai and Asian branches of General Motors still name it ECM, meaning Engine Control Module. The mounting location of engine control module usually depends on the application of the specific engine. To automotive engines, some of their engine control modules are mounted inside the engine compartment, taking the benefit of shorter wire harness connection to the engines; some of their engine control modules are mounted outside the engine compartment; taking the benefit of avoiding harsh working conditions inside the engine compartment. Cummins even attaches engine control module on its diesel engine body, making it easier for engines to be mounted onto many kinds of applications.

In order to implement DCD, an electronic DCD controller module must be electrically inserted between engine control module and individual fuel injection devices, so as to interrupt some of fuel injection actions to fuel injection devices according to predetermined deactivation pattern. Fuel injection devices involved with DCD control could include, but not limited to, individual fuel injectors for gasoline fueled engines with multiple point fuel injection system; individual fuel injectors for natural gas fueled engines with multiple point fuel injection system; individual fuel injectors for diesel fueled engines with common rail fuel injection system; distributor fuel injection pump for diesel fueled engines with distributor fuel injection pump system; individual unit fuel injectors for diesel fueled engines with unit fuel injector system; or individual unit fuel injection pump for diesel fueled engines with unit fuel injection pump system.

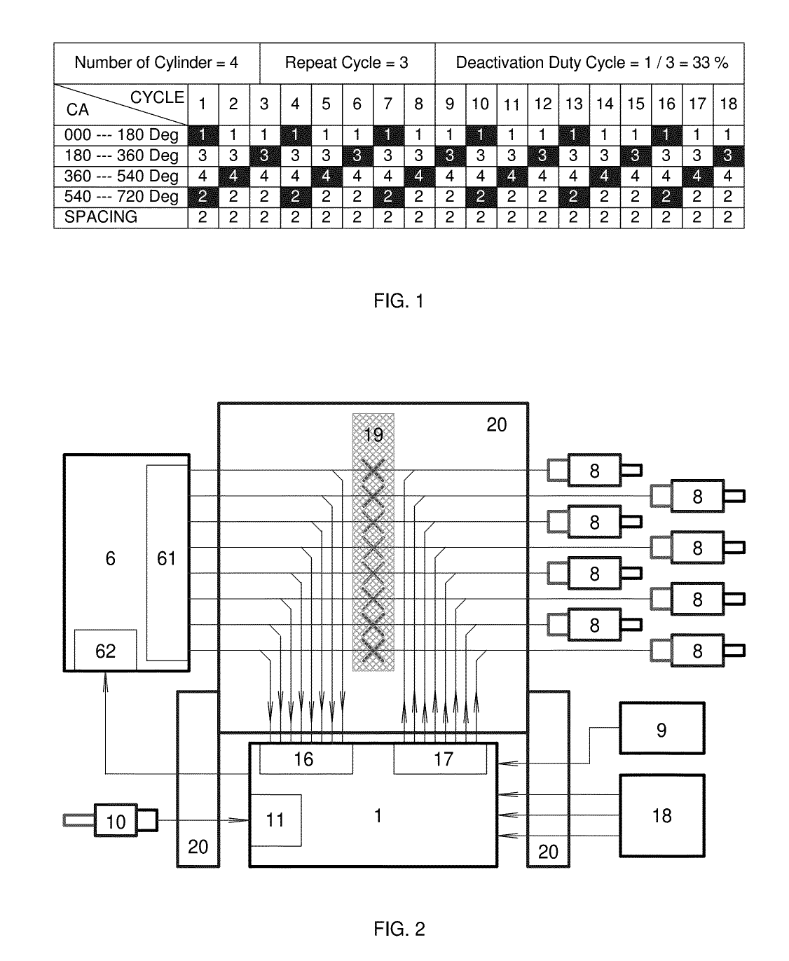

Referring to FIG. 2, a block diagram of DCD control for 8-cylinder engine in accordance with the present invention is shown. DCD control module 1 is an add-on control module to most existing engines or motor vehicles. Note that original electrical connections between original engine control module 6 and multiple fuel injection devices 8 must be cut and separated as indicated by “X” marks 19, and then electrically insert the DCD control module 1 in between. The control output port 61 of engine control module 6 would be connected with the signal input port 16 of DCD control module 1; while the control output port 17 of DCD control module 1 would be connected with multiple fuel injection devices 8. Multiple engine sensors 18 would provide DCD control module 1 with engine temperature, vehicle speed and other necessary signals. DCD control module 1 would be powered by existing engine or vehicle power supply 9. In case of the engine is fueled by gasoline or natural gas, to close fuel control loop under new oxygen balance caused by DCD, at least one wideband Lambda sensor 10 must be used to detect engine exhaust gas flow. Wideband Lambda sensor 10 would be controlled by wideband Lambda sensor controller 11, its signal would be processed by DCD control module 1 and then, be converted into the format acceptable by original vehicle engine control module 6, and be fed into Lambda sensor signal input port 62 of engine control module 6. LSU-4.2 type wideband Lambda sensor manufactured by Bosch with part number 0-258-007-057 is recommended for this application. It could sense as wide as 21% of wideband oxygen content, covering up to the oxygen content of pure air. In case of the engine is fueled by diesel or bio-diesel, or being fired with compression ignition, wideband Lambda sensor 10 and its related sensor controller 11 might be omitted.

The apparatus shown in FIG. 2 may be used to retrofit an existing engine system by cutting original electrical connections between original engine control module 6 and multiple fuel injection devices 8 indicated by “X” marks 19, and inserting aftermarket add-on DCD control module 1. In case wire cutting at “X” marks 19 is not allowed, interconnection adapter 20 could be introduced, as shown by blocks 20 in FIG. 2. Interconnection adapter 20 would integrate all the cut wires, signal inserting wires, signal bypass wires and signal pickup wires into one device, connecting 3 important system blocks together—engine control module 6, DCD control module 1 and fuel injection devices 8. As soon as Interconnection adapter 20 is inserted between engine control module 6 and its wire harness connector (not shown), the cutting and inserting at “X” marks 19 would be implemented immediately without the need to locate and cut the wires from the harness. This could be an efficient way to speed up installation and avoid wiring mistake during DCD retrofitting.

Interconnection adapter 20 could be defined as an electrical connection and mechanical mating device for retrofitting existing engines with DCD control function. It would comprise at least three port connectors facing toward three different directions—the first port connector to implement both electrical connection and mechanical mating with original engine control module, the second port connector to implement both electrical connection and mechanical mating with wire harness of original engine control module, and the third port connector to implement both electrical connection and mechanical mating with DCD control module. A plurality of the signal connections within interconnection adapter 20 would provide signal bypass connections between the first port connector and the second port connector. A plurality of the signal connections within interconnection adapter 20 would provide signal or power pickup “T” connections among all three port connectors. A plurality of the signal connections within interconnection adapter 20 would provide signal insertion “cut and insert” connections between the first port connector and the second port connector. A rigid plastic case would be expected to contain all said portions into one solid assembly.

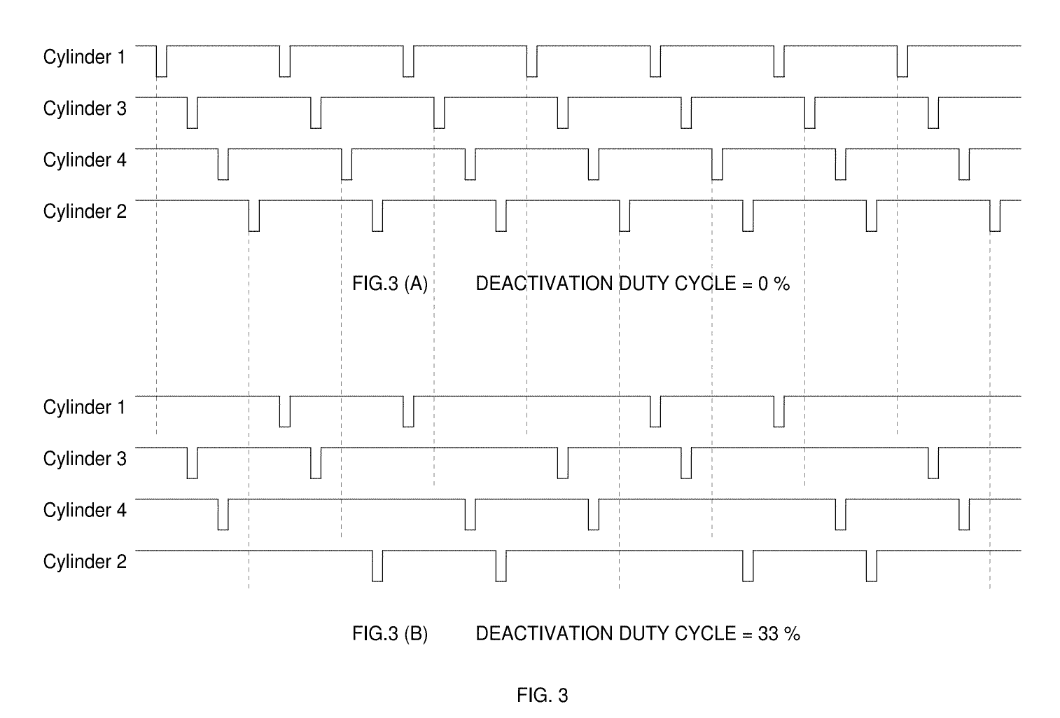

Referring now to FIG. 3, a fuel injection event waveform diagram is shown in accordance with DCD pattern based on 4-cylinder 4-stroke engine in FIG. 1 of the present invention. FIG. 3 (A) shows fuel injection event waveform when DCD is switched off, or its deactivation duty cycle equals to zero percent, where 4 fuel injectors for all 4 cylinders would work according to original fuel injection schedule determined by original engine control module. FIG. 3 (B) shows fuel injection event waveform when DCD is switched on, with its DCD duty cycle equals to 33 percent, where 4 fuel injectors for all 4 cylinders basically would work according to original fuel injection schedule determined by original engine control module with the original fuel metering pulse width, but being intentionally interrupted according to deactivation pattern shown in FIG. 1. Each individual fuel injector would be interrupted dynamically, with one interruption after every two successive regular injections, resulting one missing waveform after two successive regular ones. And no matter which cylinder, after every two successive regular injection events have happened in two previous cylinders, the injection event for the next cylinder would be interrupted.

Both FIG. 1 and FIG. 3 only show the deactivation pattern with 33% deactivation duty cycle as an example. However, there are many possible deactivation patterns and related deactivation duty cycles based on the actual engine structure and number of cylinders. The present invention could implement DCD duty cycle in a range form zero percent to 100 percent. But the actual useful DCD duty cycle would be in the range form zero percent to 75 percent maximum. The specific DCD duty cycles must be determined by number of cylinders of the engine being controlled, and the balances related to mechanical, thermal and torque measurements. An actual useful DCD duty cycle could be any one of these: one-second, or 50 percent; one-third, or 33 percent; two-thirds, or 67 percent; one-fourth, or 25 percent; three-fourths, or 75 percent; one-fifth, or 20 percent; two-fifths, or 40 percent; three-fifths, or 60 percent; one-sixth, or 17 percent; one-seventh, or 14 percent; two-sevenths, or 29 percent; three-sevenths, or 43 percent; four-sevenths, or 57 percent; five-sevenths, or 71 percent; one-eighth, or 13 percent; three-eighths, or 38 percent; five-eighths, or 63 percent; one-ninth, or 11 percent; two-ninths, or 22 percent; four-ninths, or 44 percent; five-ninths, or 56 percent; and/or being switched off, or zero, or 0 percent.

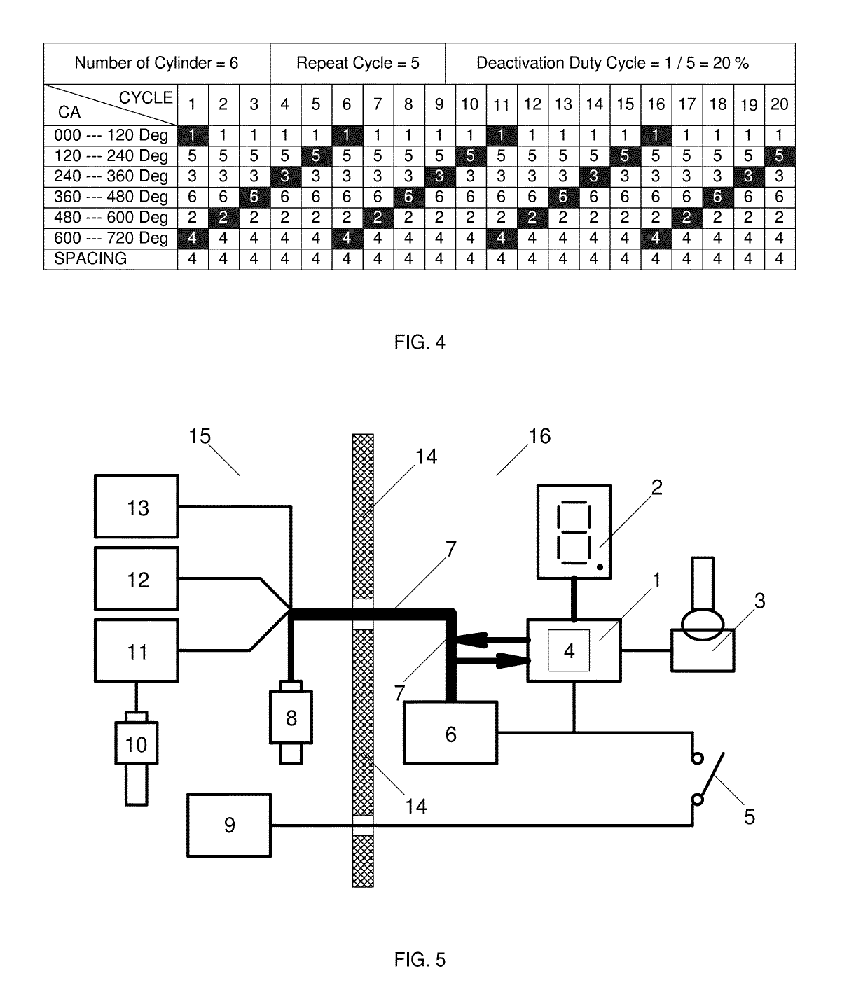

All of the above listed actual useful DCD duty cycles could be made into deactivation patterns, which could all be coded into a digital library and integrated into DCD master controller. Yet showing all of deactivation patterns within the present filing document would be very lengthy. As another example, FIG. 4 shows another deactivation pattern in accordance with the present invention. This deactivation pattern is designed for an inline 6-cylinder 4-stroke engine with a repeat cycle of 5, resulting deactivation duty cycle of ⅕, or 20 percent. Looking vertically into the pattern, for every 5 successive fuel injection events, one would be interrupted by DCD, and between two deactivated fuel injection events, 4 successive active fuel injection events would be performed. Looking horizontally into the pattern, for any cylinder and for every 5 successive engine cycles, one engine cycle would be deactivated by DCD, and between two deactivated engine cycles, 4 successive active engine cycles would be performed.

Traditional sealed-valves cylinder deactivation compresses and expands gas repeatedly in sealed cylinders. The only benefit of such sealed cylinders is reducing the gas pumping loss in two folds, with the first fold coming from reduced engine power that requires wider throttle opening, resulting higher intake manifold pressure; the secondary fold coming from the sealed cylinders that demand no gas flow, resulting even higher intake manifold pressure. However, compression process in sealed cylinder during deactivation would generate heat and rise the temperature. Once the gas temperature goes higher than that of cylinder wall or engine coolant, the heat would spread out of the cylinder wall, being carried away by the coolant. So during the compression the existing energy inside the cylinders would escape in the form of heat, causing thermodynamic loss. As a result, the expansion after the compression would be less energized, yielding less expansion work than compression work. The overall work done during a compression-expansion process could be a negative one, and such negative work would happen twice during the whole 4-stroke engine cycle, doubling thermodynamic loss. If we consider sealed cylinders as air springs, then these air springs would not bounce back as powerful as they were compressed due to the heat loss.

Even though the hot exhaust is sealed in the cylinders at the beginning of deactivation, as many automakers are doing so, the thermodynamic loss would extract their heat energy out of cylinders stroke by stoke and cycle by cycle, reaching a cooler than normal temperature eventually. Cylinder with cooler than normal temperature would suffer from many unpleasant issues like reduced lubrication, increased friction, mechanical worn-out and gas blow out. In extreme case the cylinder pressure would become negative that engine oil suck-in could be happened.

In contrast, DCD would keep the gas flow through the cylinders as usual. So its gas pumping loss reduction benefit only comes from wider throttle opening, the first fold mentioned above. Obviously, there will be no benefit from the secondary fold mentioned above because of the regular gas flow. However, the great benefit of DCD comes from thermodynamic expansion of the gas inside the cylinders.

Before the scheduled deactivation cycle, the cylinder to be deactivated have operated actively as usual at least one engine cycle, with heat addition by fuel injection(s) and fuel combustion(s) as usual. Thus the temperature of the cylinder would be brought up to the normal, or very close to the normal.

During the scheduled deactivation cycle, fuel injection of the deactivated cylinder would be interrupted electronically, but the cylinder operation cycle would remain in original 4 strokes as usual. During the intake stroke, cold fresh air from atmosphere with environment temperature would be inhaled into the cylinder. Then it would be compressed during the compression stroke. The gas temperature would be raised not only by the compression, but also by the remaining heat from the previous combustion(s). Next would be the expansion stroke, the heated compressed gas would expand inside the deactivated cylinder, pushing the piston downward while contributing a positive mechanical work. Due to the residual heat energy inside the cylinder, more expansion work is expected than the work spent for compression. This means the heat energy would be converted into mechanical energy through gas expansion. At last, the expanded gas would be discharged out of the cylinder during the exhaust stroke with much lower temperature. Some heat rejection would happen during exhaust process, as is a must process for the operation of any heat engine which always has the need of heat rejection.

After the scheduled deactivation cycle, the cylinder that has been deactivated would be reactivated as usual at least one engine cycle, with heat addition by fuel injection(s) and fuel combustion(s) as usual. Thus the temperature of the cylinder would be brought up to the normal, or very close to the normal. The more reactivated working cycles, the closer the temperature of the cylinder would be brought up to the normal, ready for the next deactivation cycle.

Thanks to the combined cycle happened along with DCD control, DCD would definitely have a positive thermodynamic gain as long as the cylinder is hot enough. Based on the fact that every cylinder does have some residual heat after normal combustion(s), the positive thermodynamic gain from DCD could be irrefutable. This gain would greatly contribute to engine fuel efficiency.

During the process of 4-stroke engine cycle, the working fluid would be kept inside the cylinder for half of the stroke period, on average, during the intake stroke; and full stroke period during the compression stroke and the expansion stroke. This results up to 63% engine cycle time on average, 75% engine cycle time maximum, for the working fluid to stay inside the cylinder, getting in touch with cylinder wall and being heated up by the cylinder before and during the expansion work. To 2-stroke engines, the working fluid would be kept inside the cylinders at an even larger percentage. Averagely half of time during scavenging, 0% to 33%, all 33% during compression and power stages, it would yield 83% engine cycle time on average, up to 100% engine cycle time maximum, for the working fluid to be heated up by the cylinder before and during the expansion work. As we have seen, 2-stroke engine has higher compatibility with residual heat recovery happened with DCD control.

In an embodiment of apparatus for the present invention, DCD control module could be applied to automotive engines that drive motor vehicles, as shown in FIG. 5, a structure diagram of DCD control system in accordance with the present invention. The whole system is physically separated by fire wall 14 into two compartments, the engine compartment 15 and passenger compartment 16, or outside the engine compartment. DCD control module 1 would contain a plurality of deactivation patterns 4, which could implement various DCD control duty cycles chosen for the specific engine. DCD control module 1 would connect with original engine control module 6 through control harness 7, have fuel injection control signals coming from engine control module 6 processed according to DCD patterns 4, and then, send to all of the individual fuel injection devices 8 through control harness 7. DCD control module 1 would interface with engine operator by numerical or alphabetic display 2 and DCD control handle 3 which would serve as a DCD duty cycle selectable switch. DCD control handle 3 could be a joystick like switch able to be operated in at least two directions, up to four operational directions, with each direction presenting one of DCD control changeovers, either for DCD duty cycle to “INCREASE”, “DECREASE”, “MAXIMIZE” or “CANCEL”. As a result, DCD duty cycle could be adjusted and switched on or off in real time according to engine operator's willing. Original engine power supply control switch, or what is called ignition switch 5, could be used to control the power supply source of DCD control module 1. Vehicle power supply 9 would provide working power to DCD control module 1 through ignition switch 5. Wideband Lambda sensor 10 would be connected with DCD control module 1 through wideband Lambda sensor controller 11 and control harness 7. Engine radiator fan 12 and engine temperature control equipment 13 would also be controlled by DCD control module 1 through control harness 7. Since engine control module 6 is located at outside the engine compartment, DCD control module 1 could be installed adjacent to engine control module 6 outside the engine compartment. Thus existing control harness 7 could be utilized to carry all the engine control signals going into or coming out of engine compartment without the need of any additional wire harness.

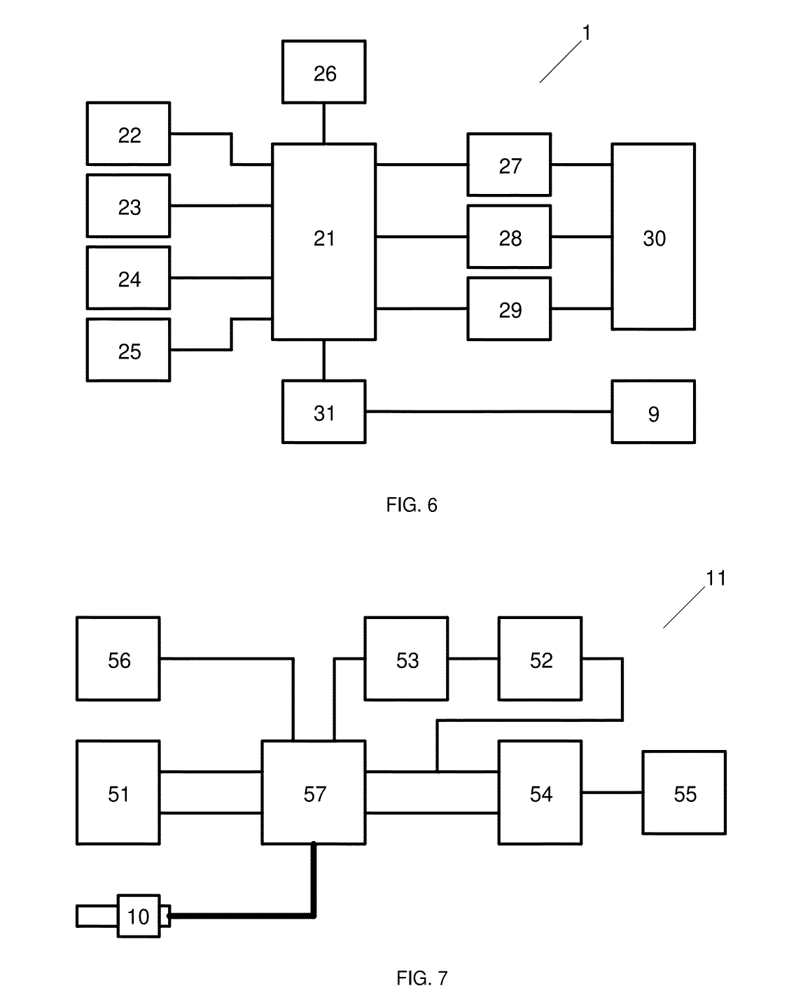

Referring now to FIG. 6, a block diagram of DCD control module 1 in accordance with the present invention is shown. Basically a master controller chip 21 must be utilized to implement the core device of DCD control module 1. Master controller chip 21 could be implemented by any microcontroller that has enough processing capability and I/O port resources. For example, Infineon's XC886-6FFA5V 8-bit single-chip microcontroller could be selected for this application. It has up to 34 digital I/O ports and up to 8 analog input ports, more then enough for DCD application. It has embedded with 24 k-byte flash memory and 1792-byte SRAM. This microcontroller is manufactured in a standard PG-TQFP-48 package, with −40 degree Celsius to +125 degree Celsius automotive grade temperature range which is most suitable for various kinds of automotive applications. Manufacturers of automotive grade microcontrollers still include Atmel, Renesas, Philips and Freescale. Another choice for master controller chip 21 could be Field Programmable Gate Array device, or FPGA for short. FPGA could be programmed into various microcontrollers and logic structures. FPGA has many device formats to choose, and also multiple choices from multiple manufacturers. Altera, Xilinx and Lattice are 3 major FPGA manufacturers. They are also providing Program Logic Device (PLD) that functions similar with FPGA but in a smaller capacity, yet still good enough for DCD control module applications.

Deactivation patterns for different duty cycles and different engines would be converted to digital data blocks and stored in the flash memory of XC886-6FFA5V microcontroller. During DCD control, the related digital data block would be checked out according to the current DCD control duty cycle. The digital data block would tell microcontroller whether to turn on fuel injection or to turn it off. For turning on fuel injection, just simply copy the fuel injection inputs to their outputs, without altering their original timing and duration determined by original engine control module. For turning off fuel injection, just simply block the current fuel injection pulse, sending no signal to the output.

Still in FIG. 6, signal input interface 22 could be used to make level translation, isolation and buffering of various digital logic input signals. These signals include all of the fuel injector control signals driven by original engine control module 6, vehicle speed signal and lightening signal for dim control. Optical coupler devices or CMOS logic devices could be used to implement signal input interface 22. Sensor interface 23 could be used to process analog signals from various engine sensors. These signals include at least wideband Lambda sensors and engine coolant temperature sensor. Operational amplifiers and CMOS analog devices could be used to process these signals in analog domain. Control switch interface 24 would be used to read the status of DCD control handle switch. This interface is better to be implemented in analog format as to reduce the number of wires. For example, using the resistance between two wires to presents the status and position of the control handle would require only two wires to reflect multiple positions of the control handle switch. System configuration switch 25 could be used to set up basic parameters of DCD control system. Display interface 26 could be utilized to drive seven-segment numerical or alphabetical display. Display interface could stream the display data in either parallel or serial format. Serial format display data streaming could reduce the number of wires for the harness connecting display unit. Usually, 4 wires could be used to the serial connection of the display unit—serial data signal wire SDA; serial clock signal wire SCK; display power supply wire VDP and common ground wire GND. Output drivers 27 would be used to drive various kinds the fuel injection devices of the engine being controlled. Control output drivers 28 could be used to drive other equipment attached to engine, such as radiator fan 12 and temperature control equipment 13. Bi-polar Darlington power transistor or power MOSFET could be used as output drivers. Wideband Lambda sensor signal processing circuit 29 could be used to provide processed Lambda sensor signal required by original engine control module 6 with suitable format. Control output signal interface 30 could be used to implement control signal connections with all the related engine equipment. DC-to-DC power converter 31 would be used to convert vehicle power supply 9 into working power required by DCD control module. Usually +14V to +5V or +3.3V step-down conversion would be required.

In case the engine is fueled by gasoline or natural gas, at least one wideband Lambda sensor controller 11 must be used to complete the closed loop Lambda control. Referring now to FIG. 7, a block diagram of wideband Lambda sensor controller 11 in accordance with the present invention is shown. This wideband Lambda sensor controller 11 could comprise heater switching power supply 51, pump current generator 52, pump current PID controller 53, pump current sampling amplifier 54, output driver 55, reference voltages 56 and wideband Lambda sensor interface 57. Heater switching power supply 51 could be used to feed the heating power into heater element inside wideband Lambda sensor 10. Under the control of pump current PID controller 53, pump current generator 52 would provide wideband Lambda sensor 10 with pump current for conveying oxygen ions. Then pump current sampling amplifier 54 would sample and amplify pump current happened onto wideband Lambda sensor 10, the yielding signal would be buffered by output driver 55, and then being fed to DCD control module 1 through control harness 7 for further processing. In other hand, the sensing voltage output reflecting Lambda value change from wideband Lambda sensor 10 would be fed back to pump current PID controller 53, so as closed loop feedback control to the pump current for conveying oxygen ions could be implemented. Moreover, reference voltages 56 would provide wideband Lambda sensor 10 with required reference voltage levels. If the sensor signal needs to be processed and/or conditioned further, a mixed-signal processor could be inserted in front of output driver 55.

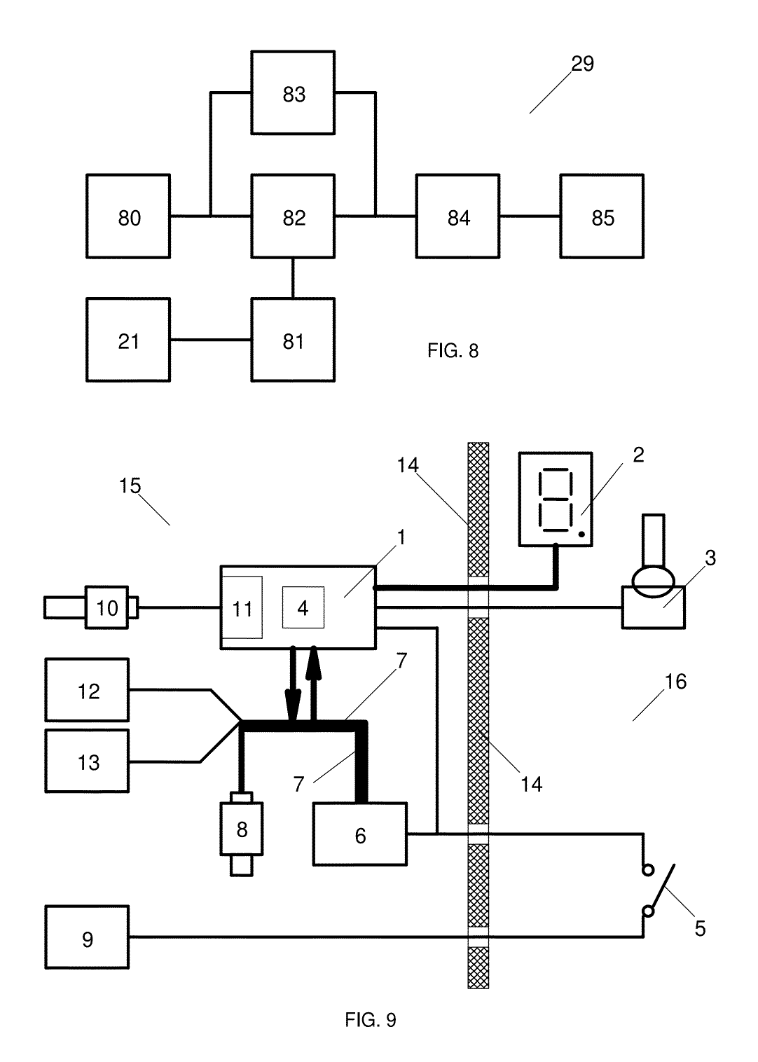

Referring now to FIG. 8, a block diagram of wideband Lambda sensor signal processing circuit 29 in accordance with the present invention is shown. Digital controlled voltage generator 81 would generate multiple threshold voltages under the control of master controller chip 21. In case original vehicle Lambda sensor is a regular narrow band Lambda sensor, wideband Lambda sensor signal 80 coming from wideband Lambda sensor controller 11 would be compared by threshold comparator 82 based on one of threshold voltages generated by digital controlled voltage generator 81. The output signal of threshold comparator 82 would posses the same character as regular narrow band Lambda sensor. It would be translated into proper level by voltage level translator 84, and then be fed into narrow band Lambda sensor input port 62 of original engine control module 6 through output driver 85. In case original vehicle Lambda sensor is a pseudo-wideband air-fuel-ratio (AFR) sensor, threshold comparator 82 would be replaced by a proportional amplifier 83 biased by one of threshold voltages generated by digital controlled voltage generator 81. The output signal of proportional amplifier 83 would posses the same character as pseudo-wideband air-fuel-ratio (AFR) sensor, with its voltage varying along with the value of air-fuel-ratio.

Regular narrow band Lambda sensor was invented by Bosch, and nowadays it is widely utilized to most gasoline engines. Such kind of Lambda sensor could only monitor very narrow range of Lambda value change. Pseudo-wideband air-fuel-ratio (AFR) sensor is manufactured by Denso and being applied to Japanese vehicles made by Toyota and Honda. Such kind of Lambda sensor could monitor wider range of Lambda value change for much precise closed loop Lambda control, but far from the full Lambda range of air-fuel combustion. These two kinds of Lambda sensor have different signal formats and functions, thus need to be handled with different processing circuits. Only LSU4.2 wideband Lambda sensor invented and manufactured by Bosch could sense full range, up to infinity, of Lambda value change for closed loop Lambda control. In case the engine being controlled is fueled by gasoline or natural gas, such kind of wideband Lambda sensor is a must for DCD control system disclosed by the present invention.

In another embodiment of apparatus for the present invention, DCD control module could be applied to large scale vehicle engines for trucks and buses, as shown in FIG. 9, another structure diagram of DCD control system in accordance with the present invention. The whole system is physically separated by fire wall 14 into two compartments, the engine compartment 15 and passenger compartment 16, or outside the engine compartment. Original engine control module 6 is located at the engine compartment 15, or even being mounted on engine body. DCD control module 1 would contain a plurality of deactivation patterns 4, which could implement various DCD control duty cycles chosen for the specific engine. DCD control module 1 would connect with original engine control module 6 through control harness 7, have fuel injection control signals coming from engine control module 6 processed according to DCD patterns 4, and then, send to all of the individual fuel injection devices 8 through control harness 7. DCD control module 1 would interface with engine operator by numerical or alphabetic display 2 and DCD control handle 3 which would serve as a DCD duty cycle selectable switch. DCD control handle 3 could be a joystick like switch able to be operated in at least two directions, up to four operational directions, with each direction presenting one of DCD control changeovers, either for DCD duty cycle to “INCREASE”, “DECREASE”, “MAXIMIZE” or “CANCEL”. As a result, DCD duty cycle could be adjusted and switched on or off in real time according to engine operator's willing. Original engine power supply control switch, or what is called ignition switch 5, could be used to control the power supply source of DCD control module 1. Vehicle power supply 9 would provide working power to DCD control module 1 through ignition switch 5. Wideband Lambda sensor 10 would be connected with DCD control module 1 through wideband Lambda sensor controller 11 and control harness 7. Engine radiator fan 12 and engine temperature control equipment 13 would also be controlled by DCD control module 1 through control harness 7. Since engine control module 6 is located at the engine compartment 15, DCD control module 1 could also be installed adjacent to engine control module 6 inside the engine compartment 15. Thus the newly added wire harnesses must travel toward outside of engine compartments as to implement the necessary interconnections between DCD control module 1 and its display 2 as well as control handle switch 3. Furthermore, wideband Lambda sensor controller 11 could also be integrated into DCD controller module 1, as both of them could be located at the same place in engine compartment 15.

In still another embodiment of apparatus for the present invention, DCD control function, including DCD control module and its related hardware blocks and software blocks, could be integrated into original engine control module. In this case, DCD control module and its related blocks would no longer be the add-on modules the original engine control system, instead, DCD control could become an integrated function in an OEM engine system. Technically, such kind of system integration could be relatively easy to implement nowadays. Such system level integration could further reduce system cost and increase system reliability as microcontroller, many components and blocks could be shared or be merged. For example, fuel injection device drivers contained inside original engine control module could be utilized as power drivers instead of being down-graded into small signal output drivers for add-on module.

In order to integrate DCD control function into original engine control module, at least these function blocks must be included with the integration, but not limited to: control signal input interfaces, sensor signal input interfaces, control signal output drivers, dynamic cylinder deactivation control algorithms, library of dynamic cylinder deactivation patterns, DCD system management functions, wideband Lambda sensor controllers, wideband Lambda sensor signal processing circuits, display drivers, and necessary DC-DC power supply.

One special feature of DCD control is the implementation of “Air-Hybrid” with cylinder residual heat recovery. Under the DCD control, cold inlet air would become the working fluid of the engine being controlled, absorbing residual heat inside the cylinders, thus expanding and contributing positive engine work. Such an innovative “Air-Hybrid” mechanism comes along with DCD control naturally and automatically. It would not only increase engine efficiency, recover residual heat and obtain extra power, but also could implement forced internal air-cooling result inside the cylinders, avoiding engine knocking and partial over-heating, and reducing the heat loss from the radiator.

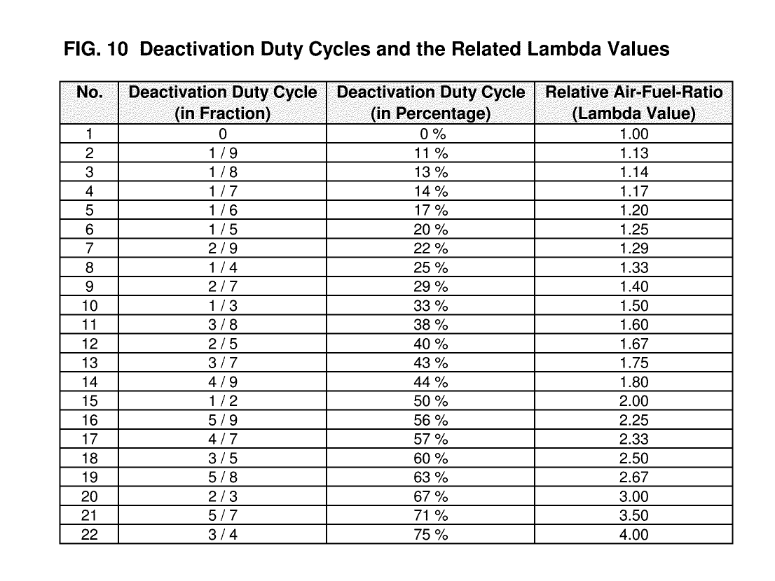

The overall operation result of Dynamic Cylinder Deactivation (DCD) applied onto an internal combustion engine could be verified through engine exhaust once the engine under control is in operation. Engine under DCD control could operate at high-Lambda oxygen-rich mode that overall engine exhaust could present higher than one relative air-fuel-ratio (Lambda) values. Different deactivation duty cycle would result in different Lambda values. Referring now to FIG. 10, a list of actual useful DCD duty cycles, in the form of both fraction and percentage, and their related Lambda values in accordance with the present invention is shown. The example shown in FIG. 1 has a deactivation duty cycle of ⅓, or 33 percent. The related Lambda value is 1.50, which means 50% times more air, or 1.50 times of original air, has been involved in overall engine operation under DCD control. Once Lambda value 1.50 is measured at the exhaust, 33 percent of deactivation duty cycle could be chemically verified. Similarly, another example shown in FIG. 4 has a deactivation duty cycle of ⅕, or 20 percent. The related Lambda value is 1.25, which means 25% times more air, or 1.25 times of original air, has been involved in overall engine operation under DCD control. Thus once Lambda value 1.25 is detected at the exhaust, 20 percent of deactivation duty cycle could have been verified chemically.

Due to fuel interruption during deactivation and oxygen-rich exhaust, the engine under DCD control would become “high-Lambda” engine that presents higher exhaust oxygen content. Less fuel put into combustion would generate less carbon dioxide, or CO2. It could be demonstrated that for an engine operating under DCD control, the percentage of CO2 reduction is simply the percentage of deactivation duty cycle. In the other hand, we could understand this green energy effect by oxygen dilution happened to the exhaust. Based on engine combustion theory, when Lambda equals to one, or DCD off, idea gasoline fuel combustion would yield about 15.2% of maximum CO2 content in the exhaust. Once DCD is turned on as in the previous examples, Lambda value would go up to 1.50 and 1.25 respectively. The CO2 contents in the exhaust would be reduced by Lambda times, or be reduced to 10.13% and 12.16% respectively. In one word, deactivation duty cycle could be verified just by detecting CO2 content from the exhaust. Actually, this could be the similar scientific method as detecting drug use from checking urine of drug users.

Besides being manually controlled by engine operator, duty cycle for dynamic cylinder deactivation could also be controlled automatically by an on-board electronic controller according to various engine and vehicle operation parameters and road conditions. These parameters could be provided by engine sensors and engine control module. Most of modern vehicles have equipped with OBD-II data readout port, which could be accessed for data streams of engine and vehicle operation parameters. For automatic DCD duty cycle control in accordance with the present invention, the required parameters include, but not limited to, vehicle speed, engine speed, engine temperature, engine intake air temperature, engine loading condition, engine torque requirement, vehicle acceleration requirement and/or engine idling condition. In a best case, automatic DCD duty cycle control could be made selectable between manual control and automatic control, just like some of advanced manual-auto transmission these days. Whatever to choose between manual control and automatic control would be all depend on engine operator's preference, or vehicle driver's choice.

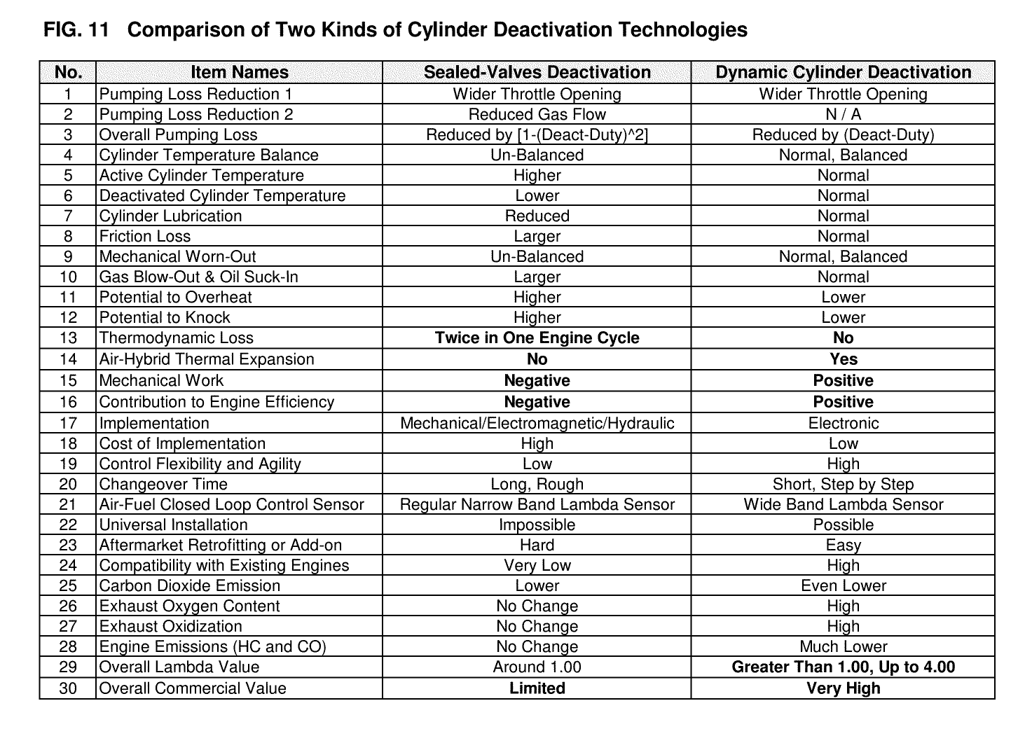

Cylinder deactivation is a proven solution to improve vehicle fuel economy. Dynamic Cylinder Deactivation (DCD) has many advantages over traditional sealed-valves cylinder deactivation. Thermodynamic efficiency gain and residual heat recovery are the most attractive features from DCD advantages. Its overall performance over traditional sealed-valves cylinder deactivation, both mechanically and thermodynamically, could be compared and summarized with the table in FIG. 11. Road driving tests to the prototype of the present invention have yielded some fuel economy gain from 10% to 18% in MPG.

Based on comparison results in FIG. 11, we could find out that DCD has much higher commercial value than its technical competitor. Thus we could expect that a new kind of cylinder deactivation, in aspects of theory, methodology and modular apparatus, is coming to human life. That is Dynamic Cylinder Deactivation (DCD) with residual heat recovery disclosed in the present invention. The innovative HEIHE cycle involved within the present invention would bring extra engine efficiency gain over traditional sealed-valves cylinder deactivation. Due to its simple electronic implementation, DCD control could not only be applied to the manufactured engines and vehicles, but also be made into aftermarket devices or add-on control modules for retrofitting millions of existing engines and vehicles.

It is believed that the Dynamic Cylinder Deactivation (DCD) with residual heat recovery in the present invention and many of its attendant advantages will be understood by the forgoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof, it is the intention of the future claims to encompass and include such changes.

What is claimed is:

1. An electronic apparatus for dynamic cylinder deactivation (DCD) control applicable to electronically-controlled multiple cylinder internal combustion engine comprising:
electronic module for DCD control;
DCD control handle switch;
display unit, in numerical or alphabetical form;
at least one, but not limited to one, wideband Lambda sensor;
at least one, but not limited to one, wideband Lambda sensor controller;
harness that connect all the above items from different locations together;
harness that interface with electronic system of the engine to be controlled; and
at least one, but not limited to one, engine interconnection adapter.

2. The apparatus according to claim 1, wherein said electronic module for DCD control can be electrically inserted and connected between original engine control module and all of the fuel injection devices; and is capable to interface and cooperate with original engine control module, engine fuel injection devices, engine sensors, engine ignition switch and automotive battery.

3. The apparatus according to claim 1, wherein fuel injection signal input ports of said electronic module for DCD control are connected with fuel injection signal outputs of original engine control module; output ports of said electronic module for DCD control are connected with all of the fuel injection devices.

4. The apparatus according to claim 1, wherein the said electronic module for DCD control is integrated with at least, but not limited to, the function blocks comprising:
fuel injection signal input interface;
engine sensor signal input interface;
fuel injection control signal output driver;
DCD control algorithm;
library of digital DCD patterns;
DCD control system management;
multiple adjustable levels of DCD duty cycle;
automatic DCD control level adjustment algorithm;
wideband Lambda sensor controller;
wideband Lambda sensor signal processor;
DCD control handle signal interface;
display driving interface; and
DC-DC step-down power supply.

5. The electronic module for DCD control according to claim 4, wherein the number of multiple adjustable levels of DCD duty cycle lies between two (2) and six (6), depending on the vehicle and its engine.

6. The electronic module for DCD control according to claim 4, wherein automatic DCD control level adjustment algorithm to control and adjust DCD duty cycle electronically is based on the signals from:
vehicle speed;
engine speed;
engine temperature;
engine intake air temperature;
engine loading condition;
vehicle torque requirement;
vehicle acceleration requirement; and
engine idling condition.

7. The apparatus according to claim 1, wherein said electronic module for DCD control comprises at least:
master controller chip implemented by either microcontroller, or Field Programmable Gate Array (FPGA) device, or Program Logic Device (PLD);
DCD control algorithms integrated into master controller chip;
library of digital DCD patterns stored inside master controller chip;
system management functions integrated into master controller chip;
optical coupler device or CMOS device as input interface;
bi-polar Darlington power transistor or power MOSFET as output driver;
at least one, but not limited to one, wideband Lambda sensor signal processing circuit;
DC-DC power supply converter as step-down power supply;
at least one engine temperature sensor signal input port;
at least two engine temperature control signal output ports;
DCD control handle signal input port;
display driving port for numerical or alphabetical display; and
vehicle speed sensor input port.

8. The electronic module for DCD control according to claim 7, wherein DCD control handle signal input port is a two-wire analog input port wherein the resistance between the two wires of the port presents the status and position of the control handle.

9. The electronic module for DCD control according to claim 7, wherein display driving port is a digital logic data output port with serial data bit sequence comprising at least 4 signal and power wires:
serial data signal wire SDA;
serial clock signal wire SCK;
display power supply wire VDP; and
common ground wire GND.

10. The electronic module for DCD control according to claim 7, wherein said wideband Lambda sensor signal processing circuit comprise at least one of:
output signal to emulate signal character required by Lambda sensor signal input port of original engine control module;
output signal that is sourced from the wideband Lambda sensor signal;
digital controlled voltage generator to provide reference voltage for threshold comparison;
voltage comparator for threshold comparison;
proportional amplifier to emulate pseudo-wideband air-fuel-ratio (AFR) sensor output;
voltage level translator to convert output signal into the required level; and
output signal driver.

11. The electronic module for DCD control according to claim 7, wherein the output signal of said wideband Lambda sensor signal processing circuit will feed signal into Lambda sensor signal input port of original engine control module, emulating the required signal characters of either:
original regular narrow band Lambda sensor; or
original pseudo-wideband air-fuel-ratio (AFR) sensor; or
original wideband Lambda sensor.

12. The apparatus according to claim 1, wherein said DCD control handle switch is a manual switch with multiple directional control handle that can be turned to multiple, at least two, selectable positions; and controllable in at least two, up to four different directions for “INCREASE”, “DECREASE”, “MAXIMIZE” and “CANCEL” control functions respectively, so as to select the current control level of DCD duty cycle.

13. The DCD control handle switch according to claim 12, wherein the control functions of four different directions comprise:
direction of “INCREASE” increases DCD duty cycle to the next larger level until the maximum level is reached;
direction of “DECREASE” decreases DCD duty cycle to the next smaller level until the minimum level is reached;
direction of “MAXIMIZE” forces DCD duty cycle to the maximum level; and
direction of “CANCEL” forces DCD duty cycle to the minimum level, with DCD function being switched off.

14. The apparatus according to claim 1, wherein said display unit is used to display the current level of DCD duty cycle in at least one-digit numerical format or alphabetical format.

15. The apparatus according to claim 1, wherein said wideband Lambda sensor controller comprise:
at least one switching power supply to power the heater inside wideband Lambda sensor;
at least one pump current PID controller to control pump current generator;
at least one pump current generator to feed wideband Lambda sensor with pump current;
at least one pump current sampling amplifier to detect and amplify pump current;
at least two reference voltage sources to bias wideband Lambda sensor;
at least one output signal driver to send signal out;
at least one mixed-signal processor to process sensor signal digitally; and
sensor interface that makes electrical connection with wideband Lambda sensor.

16. The apparatus according to claim 1, wherein said harness that connect all the electronic module for DCD control related items from different locations together comprise at least:
harness connecting DCD control handle switch to electronic module for DCD control;
harness connecting display unit to electronic module for DCD control;
harness connecting wideband Lambda sensor(s) to wideband Lambda sensor controller(s); and
harness connecting wideband Lambda sensor controller(s) to electronic module for DCD control.

17. The apparatus according to claim 1, wherein said harness that interface with electronic system of the engine to be controlled comprise at least:
harness connecting original engine control module to electronic module for DCD control;
harness connecting electronic module for DCD control to engine fuel injection devices;
harness connecting engine sensors to electronic module for DCD control; and
harness connecting engine ignition switch and battery to electronic module for DCD control.

18. The apparatus according to claim 1, wherein said interconnection adapter is an electrical connection and mechanical mating device comprising:
at least three port connectors facing toward three different directions;
the first port connector implements both electrical connection and mechanical mating with original engine control module;
the second port connector implements both electrical connection and mechanical mating with the harness of original engine control module;
the third port connector implements both electrical connection and mechanical mating with electronic module for DCD control;
a plurality of the signal connections within said interconnection adapter use signal bypass connections between the first port connector and the second port connector;
a plurality of the signal connections within said interconnection adapter use signal or power pickup “T” connections among all three port connectors;
a plurality of the signal connections within said interconnection adapter use signal “cut and insert” connections by cutting signals between the first port connector and the second port connector and inserting signals from the third port connector; and
rigid plastic case that houses all said portions into one solid assembly.

19. The apparatus according to claim 1, wherein said electronic module for DCD control can be installed at the same compartment with original engine control module which is located at different compartment from the engine; wherein said wideband Lambda sensor(s) and wideband Lambda sensor controller(s) can be installed at the same compartment with the engine but different compartment with electronic module for DCD control and original engine control module; wherein original harness traveling between different compartments could be utilized to implement the necessary interconnections without additional wiring.

20. The apparatus according to claim 1, wherein said electronic module for DCD control can be installed at the same compartment with original engine control module which is located at the same compartment with the engine; wherein said wideband Lambda sensor(s) and wideband Lambda sensor controller(s) can be installed at the same compartment with the engine and the same compartment with electronic module for DCD control and original engine control module; wherein the newly added harnesses must travel toward outside of engine compartment as to implement the necessary interconnections between electronic module for DCD control and its display unit as well as control handle switch; wherein said wideband Lambda sensor controller(s) can also be integrated into the said electronic module for DCD control.
